(19) United States
(12) Patent Application Publication
(10) Pub. No.: US 2010/0062255 A1
(43) Pub. Date: Mar. 11, 2010

(54) GYPSUM PRODUCT AND PROCESS FOR ITS PREPARATION

(76) Inventors: Reijo Aksela, Espoo (FI); Outi Gronfors, Espoo (FI); Pasi Hagelberg, Espoo (FI); Perttu Heiska, Espoo (FI); Hanna-Mari Kangaslahti, Espoo (FI); Jori Kerala, Oulu (FI); Jarmo Reunanen, Oulu (FI); Esko Tirronen, Espoo (FI); Tarja Turkki, Helsinki (FI)

Correspondence Address: CANTOR COLBURN, LLP, 20 Church Street, 22nd Floor, Hartford, CT, 06103, US

(21) Appl. No.: 12/525,129

(22) PCT Filed: Feb. 1, 2008
(86) PCT No.: PCT/FI2008/000021

§ 371 Date: Nov. 11, 2009

(30) Foreign Application Priority Data
Feb. 2, 2007 (FI) 20070093

(51) Int. Cl. C01F 11/46; C04B 11/06; C04B 14/02

(52) U.S. Cl. 428/402; 423/555

(57) ABSTRACT

The invention relates to a gypsum product which consists of essentially intact crystals having a size of between 0.1 and below 2.0 μm. The product is especially suitable as a coating pigment or filler in paper manufacture. The invention also relates to a process for the preparation of a gypsum product, wherein calcium sulphate hemihydrate and/or calcium sulphate anhydrite, water and a crystallization habit modifier are contacted so that the calcium sulphate hemihydrate and/or calcium sulphate anhydrite and the water are reacted with each other and form a crystalline gypsum product. The calcium sulphate hemihydrate and/or calcium sulphate anhydrite is/are used in such an amount that the reaction mixture formed from the calcium sulphate hemihydrate and/or calcium sulphate anhydrite, the water and the crystallization habit modifier has a dry matter content of between 50 and 84% by weight. Then, said gypsum product can be formed which consists of essentially intact crystals having a size of between 0.1 and below 2.0 μm.

### OBJECTS OF THE INVENTION

The invention relates to a gypsum product. A gypsum product is for example a coating pigment, or a filler pigment used in the production of paper. The invention also relates to a process for the preparation of a gypsum product wherein calcium sulfate hemihydrate and/or calcium sulfate anhydrite, water and a crystallization habit modifier are contacted so that the calcium sulfate hemihydrate and/or calcium sulfate anhydrite and the water react with each other and form a crystalline gypsum product.

### BACKGROUND OF THE INVENTION

Gypsum or calcium sulfate dihydrate CaSO₄.2H₂O is suitable as material for both coating pigment and filler, especially in paper products. Especially good coating pigment and filler is obtained if the particular gypsum has high brightness, gloss and opacity. The gloss is high when the particles are sufficiently small, flat and broad (platy). The opacity is high when the particles are refractive, small and of equal size (narrow particle size distribution).

The morphology of the gypsum product particles can be established by examining scanning electron micrographs. Useful micrographs are obtained e.g. with a scanning electron microscope of the type Philips FEI XL 30 FEG.

The size of the gypsum product particles is expressed as the weight average diameter D₅₀ of the particles contained therein. More precisely, D₅₀ is the diameter of the presumably round particle, smaller than which particles constitute 50% of the total particle weight. D₅₀ can be measured with an appropriate particle size analyzer, such as Sedigraph 5100.

The flatness of a crystal means that it is thin. The form of flat crystals is suitably expressed by means of the shape ratio SR. The SR is the ratio of the crystal length (the longest measure) to the crystal thickness (the shortest transverse measure). By the SR of the claimed gypsum product is meant the average SR of its individual crystals.

The platyness of a crystal means that it is broad. Platyness is suitable expressed by means of the aspect ratio AR. The AR is the ratio between the crystal length (the longest measure) and the crystal width (the longest transverse measure). By the AR of the claimed gypsum product is meant the average AR of its individual crystals.

Both the SR and the AR of the gypsum product can be estimated by examining its scanning electron micrographs. A suitable scanning electron microscope is the above mentioned Philips FEI XL 30 FEG.

Equal crystal particle size means that the crystal particle size distribution is narrow. The width is expressed as the gravimetric weight distribution WPSD and it is expressed as (D₇₅−D₂₅)/D₅₀ wherein D₇₅, D₂₅ and D₅₀ are the diameters of the presumably round particles, smaller than which particles constitute 75, 25 and 50%, respectively, of the total weight of the particles. The width of the particle distribution is obtained with a suitable particle size analyzer such as the above mentioned type Sedigraph 5100.

Gypsum occurs as a natural mineral or it is formed as a by-product of chemical processes, e.g. as phosphogypsum or flue gas gypsum. In order to refine the gypsum further by crystallizing it into coating pigment or filler, it must first be calcined into calcium sulfate hemihydrate (CaSO₄.½H₂O), after which it may be hydrated back by dissolving the hemihydrate in water and precipitating to give pure gypsum. Calcium sulfate may also occur in the form of anhydrite lacking crystalline water (CaSO₄).

Depending on the calcination conditions of the gypsum raw material, the calcium sulfate hemihydrate may occur in two forms; as α- and β-hemihydrate. The β-form is obtained by heat-treating the gypsum raw material at atmospheric pressure while the α-form is obtained by treating the gypsum raw material at a steam pressure which is higher than atmospheric pressure or by means of chemical wet calcination from salt or acid solutions at 45° C.

WO 88/05423 discloses a process for the preparation of gypsum by hydrating calcium sulfate hemihydrate in an aqueous slurry thereof, the dry matter content of which is between 20 and 25% by weight. Gypsum is obtained, the largest measure of which is from 100 to 450 μm and the second larges measure of which is from 10 to 40 μm.

AU620857 (EP0334292 A1) discloses a process for the preparation of gypsum from a slurry containing not more than 33.33% by weight of ground hemihydrate, thereby yielding needle-like crystals having an average size of between 2 and 200 μm and an aspect ratio between 5 and 50. See page 15, lines 5 to 11, and the examples of this document.

US 2004/0241082 describes a process for the preparation of small needle-like gypsum crystals (length from 5 to 35 μm, width from 1 to 5 μm) from an aqueous slurry of hemihydrate having a dry matter content of between 5 and 25% by weight. The idea in this US document is to reduce the water solubility of the gypsum by means of an additive in order to prevent the crystals from dissolving during paper manufacture.

The above papers expressly aim at preparing needle-like crystals which are suitable as reinforcement. In them gypsum products and their preparation are described, the needle-like forms of which are unsatisfactory when striving for high gloss and opacity.

As was stated above, in order to achieve high gloss and opacity, very small particles are needed. Such particles have so far been obtained only by grinding gypsum. The energy consuming grinding however leads to a broken crystals and a broad particle size distribution (FIG. 11) which are harmful both with respect to gloss and opacity. Thus, with prior known techniques, optimal gloss and opacity are not achieved.

### DESCRIPTION OF THE INVENTION

The aim of the invention is to provide a gypsum product, such as a coating pigment or filler, the crystals of which are intact, as small as possible and preferably flat and of equal size. These properties give the product high gloss and opacity. The purpose of the invention is also to provide a process for the preparation of such a product.

The above mentioned purposes have now been achieved with a gypsum product, mainly characterized in that it consists of essentially intact crystals having a size from 0.1 μm to below 2.0 μm (0.1 μm≦D₅₀<2.0 μm). By essentially intact crystals is meant crystal particles which are not mechanically broken, but the crystal surfaces of which are preserved essentially intact. For example, FIG. 11 shows gypsum with broken particles, obtained by grinding, whereas FIGS. 1 to 5 and 8 show gypsum having intact crystals, prepared by crystallization according to embodiments of the invention. Preferred crystal sizes range from 0.2 to below 2.0 μm.

It is preferable that the shape ratio SR of the crystals of the claimed gypsum product is at least 2.0, preferably between 2.0 and 50, most preferably between 3.0 and 40. The aspect ratio AS of the crystals is preferably between 1.0 and 10, most preferably between 1.0 and below 5.0. The width of the particle size distribution WPDS=(D₇₅D₂₅)/D₅₀, see above, is preferably below 2.0, more preferably below 1.25, most preferably below 1.10, which ensures that the product is homogeneous. FIG. 11 shows that a ground product according to the state of the art has particles of very different sizes.

When the above mentioned criteria are fulfilled, a gypsum product is obtained giving high whiteness and opacity.

As was stated before, the gypsum product of the invention is typically a coating filler pigment. In addition to use as a paper additive, it can also be used as plastics filler, and as a raw material in glass industry, cosmetics, printing inks, building materials and paints.

According to one embodiment of the invention, the gypsum product is a coating pigment and consists of crystals having a size of between 0.1 and 1.0, preferably between 0.5 and 1.0 μm. According to another embodiment, it is a filler and consists of crystals having a size of between 1.0 and below 2.0 μm.

As was initially stated, the invention also relates to a process for the preparation of a gypsum product, wherein calcium sulfate hemihydrate and/or calcium sulfate anhydrite, water and a crystallization habit modifier are contacted so that the calcium sulfate hemihydrate and/or calcium sulfate anhydrite and the water react with each other and form a crystalline gypsum product.

Characteristic for the claimed process is that the calcium sulfate hemihydrate and/or calcium sulfate anhydrite is/are used in such an amount that the reaction mixture formed from the calcium sulfate hemihydrate and/or calcium sulfate anhydrite, the water and the crystallization habit modifier has a dry matter content of between 50 and 84% by weight, in order to obtain a gypsum product which consists of essentially intact crystals having a size of between 0.1 and below 2.0 μm (0.1 μm≦D₅₀<2.0 μm). The idea of the invention is thus as simple as clever; in order to obtain fine gypsum, no grinding is needed, but merely crystallization from aqueous slurry having said high dry matter content and containing a crystallization habit modifier.

With a crystal habit modifier and high dry matter content, all the other above mentioned desirable product properties have also been achieved.

In the claimed process, the calcium sulfate hemihydrate and/or calcium sulfate anhydrite are preferably used in such an amount that the reaction mixture formed from it/them, the water and the crystallization habit modifier has a dry matter content of between 57 and 84% by weight, most preferably between 60 and 80% by weight. In this connection, the term “dry matter content” means essentially the same as “solids content”, as the dissolved hemihydrate and/or anhydrite forming a part of the “dry matter” is very small compared to the amount of undissolved hemihydrate and/or anhydrite forming the initial “solids content”.

The temperature of the water in the reaction mixture can be anything between 0 and 100° C. Preferably, the temperature is between 0 and 80° C., more preferably between 0 and 50° C., even more preferably between 0 and 40° C., most preferably between 0 and 25° C.

In a general embodiment of the invention, the hemihydrate and/or calcium sulfate anhydrite, the water and the crystallization habit modifier are contacted in any order. It is, however, preferable to contact the crystallization habit modifier with the water before the hemihydrate and/or anhydrite.

According to one embodiment of the invention, the crystallization habit modifier is an inorganic acid, oxide, base or salt. Examples of useful inorganic oxides, bases and salts are AlF₃, Al₂(SO₄)₃, CaCl₂, Ca(OH)₂, H₃BO₄, NaCl, Na₂SO₄, NaOH, NH₄OH, (NH₄)₂SO₄, MgCl₂, MgSO₄ and MgO.

According to another embodiment, the crystallization habit modifier is an organic compound, which is an alcohol, an acid or a salt. Suitable alcohols are methanol, ethanol, 1-butanol, 2-butanol, 1-hexanol, 2-octanol, glycerol, i-propanol and alkyl polyglucoside based C₈-C₁₀-fatty alcohols.

The crystallization habit modifier is preferably a compound having in its molecule one or several carboxylic or sulfonic acidic groups, or a salt of such a compound. Among the organic acids may be mentioned carboxylic acids such as acetic acid, propionic acid, succinic acid, citric acid, tartaric acid, ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), and sulfonic acids such as amino-1-naphthol-3,6-disulfonic acid, 8-amino-1-naphthol-3,6-disulfonic acid, 2-aminophenol-4-sulfonic acid, anthrachinone-2,6-disulfonic acid, 2-mercaptoethanesulfonic acid, poly(styrene sulfonic acid), poly(vinylsulfonic acid), as well as the di-, tetra- and hexa-aminostilbenesulfonic acids.

Among the organic salt may be mentioned the salts of carboxylic acids such as Mg formiate, Na- and NH₄-acetate, Na₂-maleate, NH₄-citrate, Na₂-succinate, K-oleate, K-stearate, Na₂-ethyelendiamine tetraacetic acid (Na₂-EDTA), Na₆-aspartamic acid ethoxy succinate (Na₆-AES) and Na₆-aminotriethoxy succinate (Na₆-TCA).

Also the salt of sulfonic acids are useful, such as Na-n-(C₁₀-C₁₃)-alkylbenzene sulfonate, C₁₀-C₁₆-alkylbenzene sulfonate, Na-1-octyl sulfonate, Na-1-dodecane sulfonate, Na-1-hexadecane sulfonate, the K-fatty acid sulfonates, the Na—C₁₄-C₁₆-olefin sulfonate, the Na-alkylnaphthalene sulfonates with anionic or non-ionic surfactants, di-K-oleic acid sulfonates, as well as the salts of di-, tetra-, and hexaminostilbene sulfonic acids. Among organic salts containing sulfur should also be mentioned the sulfates such as the C₁₂-C₁₄-fatty alcohol ether sulfates, Na-2-ethyl hexyl sulfate, Na-n-dodecyl sulfate and Na-lauryl sulfate, and the sulfosuccinates such as the monoalkyl polyglycol ether of Na-sulfosuccinate, Na-dioctyl sulfosuccinate, and Na-dialkyl sulfosuccinate.

Phosphates may also be used, such as the Na-nonylphenyl- and Na-dinonyl phenylethoxylated phosphate esters, the K-aryl ether phosphates, as well as the triethanolamine salts of polyaryl polyetherphosphate.

As crystallization habit modifier may also be used cationic surfactants such as octyl amine, triethanol amine, di(hydrogenated animal fat alkyl) dimethyl ammonium chloride, and non-ionic surfactants such as a variety of modified fatty alcohol ethoxylates. Among useful polymeric acids, salts, amides and alcohols may be mentioned the polyacrylic acids and polyacrylates, the acrylate-maleate copolymers, polyacrylamide, poly(2-ethyl-2-oxazoline), polyvinyl phosphonic acid, the copolymer of acrylic acid and allylhydroxypropyl sulfonate (AA-AHPS), poly-α-hydroxyacrylic acid (PHAS), polyvinyl alcohol, and poly(methyl vinyl ether—alt.-maleic acid).

Especially preferable crystallization habit modifiers are ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), the di-, tetra- and hexa-aminostilbenesulfonic acids and their salts such as Na-aminotriethoxy succinate (Na₆-TCA), as well as the alkylbenzenesulfonates.

In the process of the invention, the crystallization habit modifier is preferably used in an amount of 0.01 to 5.0%, most preferably 0.02-1.78%, based on the weight of the calcium sulfate hemihydrate and/or calcium sulfate anhydrite.

In the process according to the invention, β-calcium sulfate hemihydrate is typically used. It may be prepared by heating gypsum raw-material to a temperature of between 140 and 300° C., preferably from 150 to 200° C. At lower temperatures, the gypsum raw-material is not sufficiently dehydrated and at higher temperatures it is over-dehydrated into anhydrite. Calcinated calcium sulfate hemihydrate usually contains impurities in the form of small amounts of calcium sulfate dihydrate and/or calcium sulfate anhydrite. It is preferable to use β-calcium sulfate hemihydrate obtained by flash calcination, e.g., by fluid bed calcination, whereby the gypsum raw-material is heated to the required temperature as fast as possible.

It is also possible to use calcium sulfate anhydrite as starting material for the process of the invention. The anhydrite is obtained by calcination of gypsum raw material. There are three forms of anhydrite; the first one, the so-called Anhydrite I, is unable to form gypsum by reaction with water like the insoluble Anhydrites II-u and II-E. The other forms, the so called Anhydrite III, also known as soluble anhydrite has three forms: β-anhydrite III, β-anhydrite III′, and α-anhydrite III and Anhydrite II-s form pure gypsum upon contact with water.

As the calcium sulfate hemihydrate and/or calcium sulfate anhydrite, water and crystallization habit modifier have been contacted, they are allowed to react into calcium sulfate dihydrate i.e. gypsum. The reaction takes e.g. place by mixing, preferably by mixing strongly, said substances together for a sufficient period of time, which can easily be determined experimentally. Strong mixing is necessary because at the claimed high dry matter contents, the slurry is thick and the reagents do not easily come into contact with each other. Preferably the hemihydrate and/or anhydrite, the water and the crystallization habit modifier are mixed at the above mentioned temperature given for the water. The initial pH is typically between 3.5 and 9.0, most preferably between 4.0 and 7.5. If necessary, the pH is regulated by means of an aqueous solution of NaOH and/or H₂SO₄, typically a 10% solution of NaOH and/or H₂SO₄.

Because gypsum has a lower solubility in water than hemihydrate and anhydrite, the gypsum formed by the reaction of hemihydrate and/or anhydrite with water immediately tends to crystallize from the water medium. The crystallization is according to the invention regulated by means of the above mentioned crystallization habit modifier so that a useful product according to the invention is obtained. The recovered gypsum can be left in the water medium as a slurry or it can be recovered in dry form.

According to one embodiment of the invention, the crystallized and/or recovered gypsum is dispersed with a dispersing agent. Useful dispersing agents are the following: lignosulfonates such as Na lignosulfonate, condensation products of aromatic sulfonic acids with formaldehyde such as the condensed naphthalene sulfonates, dispersing anionic polymers, and copolymers made from anionic monomers or made anionic after polymerization, polymers containing repeating units having anionic charge such as carboxylic and sulfonic acids, their salts and combinations thereof. Also phosphates, non-ionic and cationic polymers, polysaccharides and surfactants may be used.

Among the anionic polymers described above are e.g. the poly(meth)acrylates, polyacrylate-maleate, polymaleate, poly-α-hydroxyacrylic acid, polyvinylsulfonate, polystyrene sulfonate, poly-2-acrylamide-2-methyl propane sulfonate and polyvinyl sulfonate.

A typical phosphate useful as dispersing agent is Na hexamethaphosphate. Typical non-ionic polymers are polyvinyl alcohol, polyvinyl pyrrolidone, the polyalkoxysilanes, and the polyethoxyalcohols. Cationically charged dispersing polymers are, for example, the dicyandiamide-formaldehyde polymers. Among polysaccharides should be mentioned native and modified starch, or modified cellulose such as carboxymethyl cellulose, and their derivatives.

Useful surfactants are anionic surfactants such as carboxylic acids, sulfonic acids sulfuric acid esters, phosphoric acids and polyphosphoric acid esters and their salts, non-ionic surface active substances such as ethoxylated alcohols, ethoxylated alkyl phenols, ethoxylated carboxylic acid esters and ethoxylated carboxylic acid amides, and cationic surface active substances such as acid-free amines, amines containing oxygen, amines containing an amide bond, and quaternary ammonium salts.

When dispersing gypsum, the amount of dispersing agent used is preferably from 0.01 to 5.0%, preferably from 0.05 to 3.0%, based on the weight of the gypsum.

If required, the gypsum product of the invention is also treated with other additives. A typical additive is a biocide which prevents the activity of microorganisms when storing and using the gypsum product.

Finally, the formed, recovered, dispersed and/or additive-treated gypsum product may be sieved in order to obtain gypsum particles having the desired size. A final bleaching step may also be included.

On the following a few examples are presented, the mere purpose of which is to illuminate the invention.

### EXAMPLES

First, general information about the syntheses and product analyses is disclosed. Then, the figures are identified, after which data about each example is presented. Finally, a table showing the raw materials, the reaction conditions and the product properties is shown.

### Synthesis

General information is first presented. A method optimization for the paper pigments was carried out. The parameters were:

| | |
|---|---|
| Habit modifier (w-% of DH(dihydrate)) | 0.100-0.543 |
| Tj (jacket temperature, ° C.) | 2-100 |
| pH | 3.7-7 |
| HH (initial hemihydrate, w-%) | 50-80 |

The reaction was carried out either at system pH or the pH was adjusted to the desired value by addition of 10% NaOH or 10% H₂SO₄. The amount of habit modifier chemical is calculated as percent of the precipitated calcium sulfate dihydrate (w-% of DH).

The experiments were performed with the following equipment.

1. To a reactor with shell cooler, Tj 2-20° C., the hemihydrate is added as a batch to the water containing the crystallization habit modifier and other possible chemicals. The slurry containing 57-60% dry matter is stirred using a Heidolph-mixer (ca. 250-500 rpm). The initial pH of the slurry is measured at time t=1 min.

The progress of the reaction was followed using mixer torque measurement and thermometers.

2. The reactor was of Hobart type N50CE, keeping the temperature of the reaction between 10-100° C. The hemihydrate and the chemicals are added batchwise to the aqueous liquid phase and a hemihydrate slurry with an initial solids of 57-80 w-% is obtained. Mixing speed is ca. 250-500 rpm. Reaction is carried out at system pH.

3. MLH12 MAP laboratory mixer. Hemihydrate is added as batch to the reactor and water with chemicals is added into the hemihydrate without mixing. Mixing (ca. 200 rpm) is then turned on and the starting solids content of the slurry is 57-80 w-%. Reaction is carried out at system pH.

### Analysis

The pH and temperature of the reactor were monitored by Knick Portamess 911 pH-electrode. Morphology of calcium sulfate dihydrate was studied by using FEI XL 30 FEG scanning electron microscope. Conversion of hemihydrate to dihydrate was analyzed using Mettler Toledo TGA/SDTA85 1/1100-thermogravimetric analyzer (TG). Crystal structure was determined with Philips X'pert x-ray powder diffractometer (XRD). Particle size and distribution were studied using a Sedigraph 5100 particle sizer. The samples were prepared in methanol. The shape ratio and aspect ratio was measured by examining at least ten particles found in the electron microscope micrographs.

### FIGURES

In FIGS. 1-5 are shown electron microscope micrographs of calcium sulfate dihydrate products of examples 1-5. See also the summaries of the examples.

In FIGS. 6-11 is shown examples of the use of the platy calcium sulfate pigments in coating and filling application of paper.

In FIG. 6 is shown an electron microscope image of the precipitated calcium sulfate pigment used in coating tests of wood free fine paper. The studied property was paper gloss.

In FIG. 7 is shown gloss results using precipitated calcium sulfate dihydrate together with kaolin and compared with a reference. It can be seen that with coat weight of 10 g/m² combination of calcium sulfate dihydrate and kaolin gives comparable gloss to reference. Thus precipitated gypsum can be used to replace calcium carbonate in glossy coating colors.

In FIG. 8 is shown an electron microscope image of the precipitated calcium sulfate pigment used in SC-paper filler tests. The studied properties were opacity, porosity and tensile strength of paper.

In FIG. 9 is shown the opacity as a function of tensile strength in filler application. Precipitated gypsum pigment was used together with titanium dioxide. Higher tensile strength with gypsum pigment enables increased filler level and similar opacity with reference pigments.

In FIG. 10 is shown the brightness as a function of tensile strength in filler application. Precipitated gypsum pigment was used together with titanium dioxide. Higher tensile strength with gypsum pigment enables increased filler level. Similar brightness with PCC can be obtained at higher tensile strength.

FIG. 11 shows a gypsum product having small particles prepared by grinding according to the prior art.

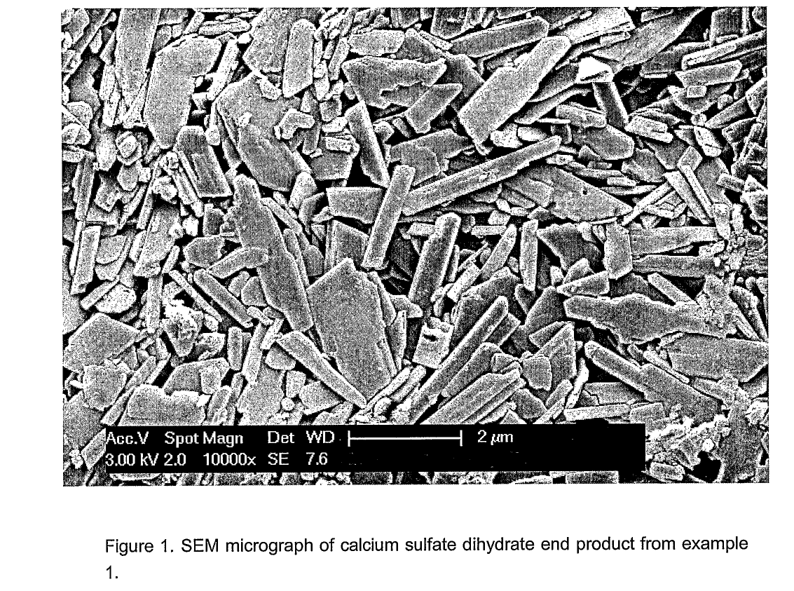

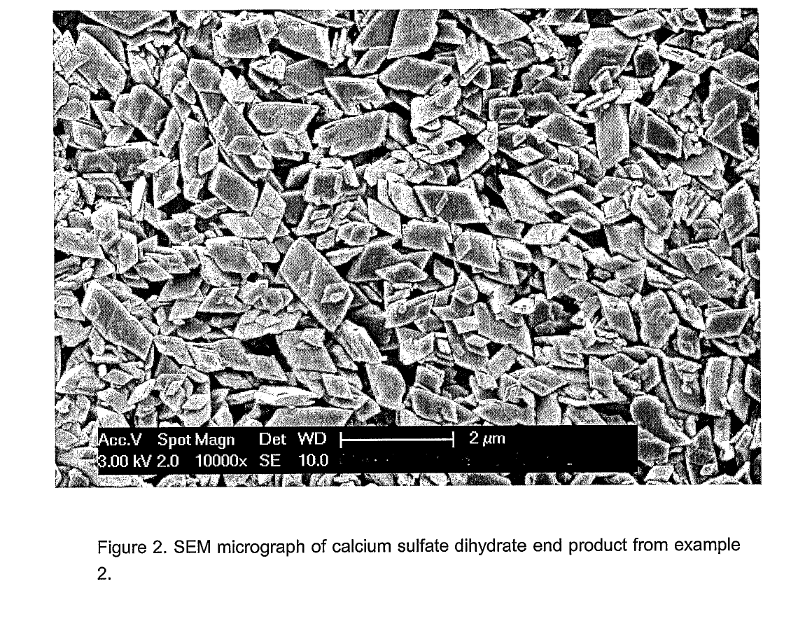

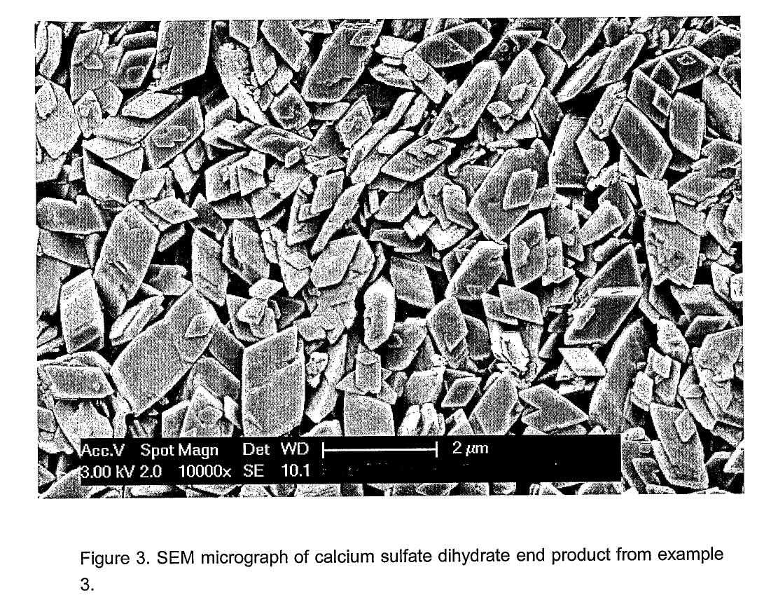

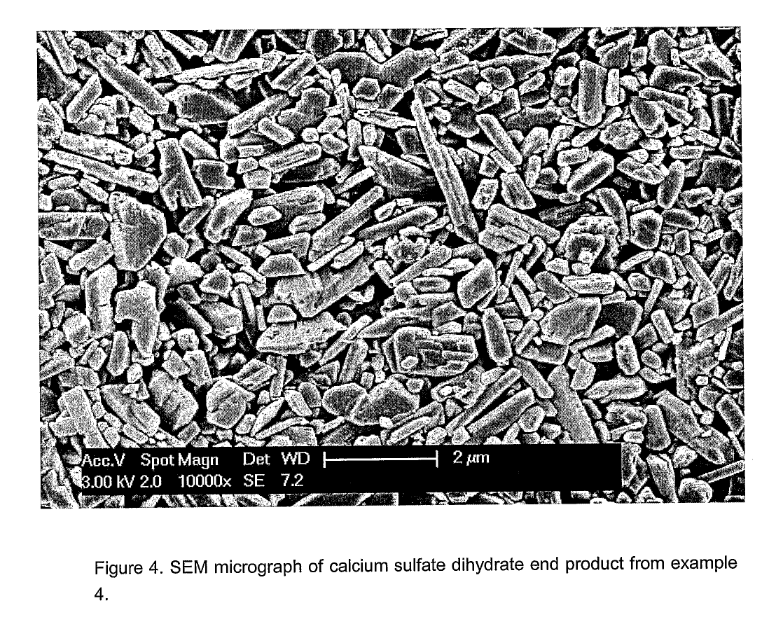

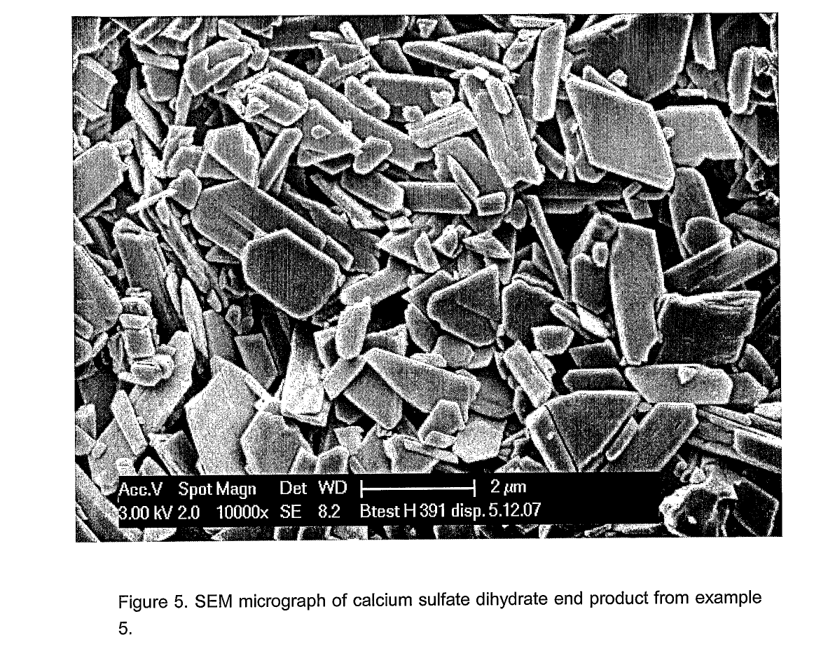

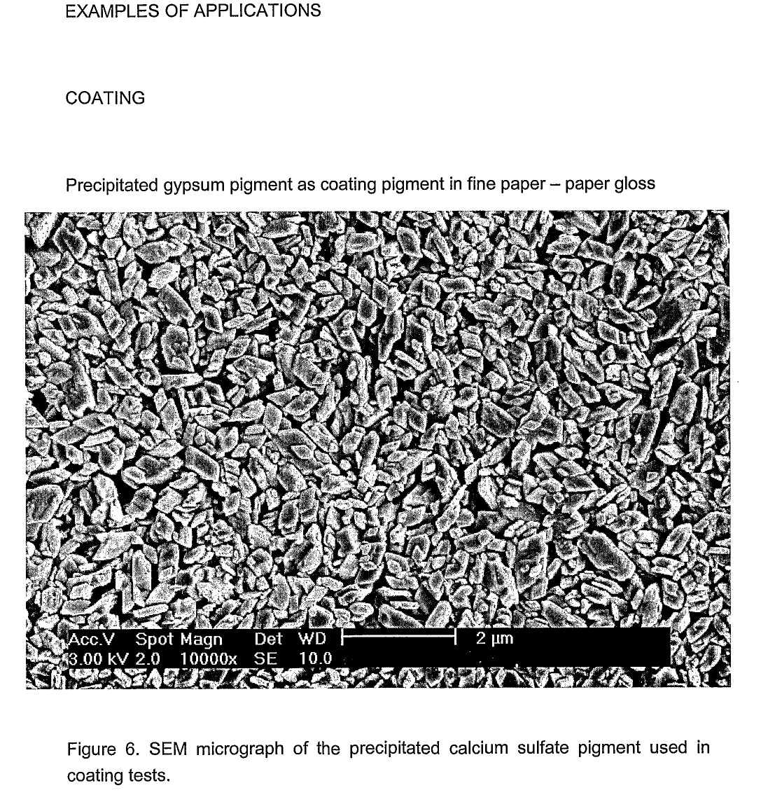

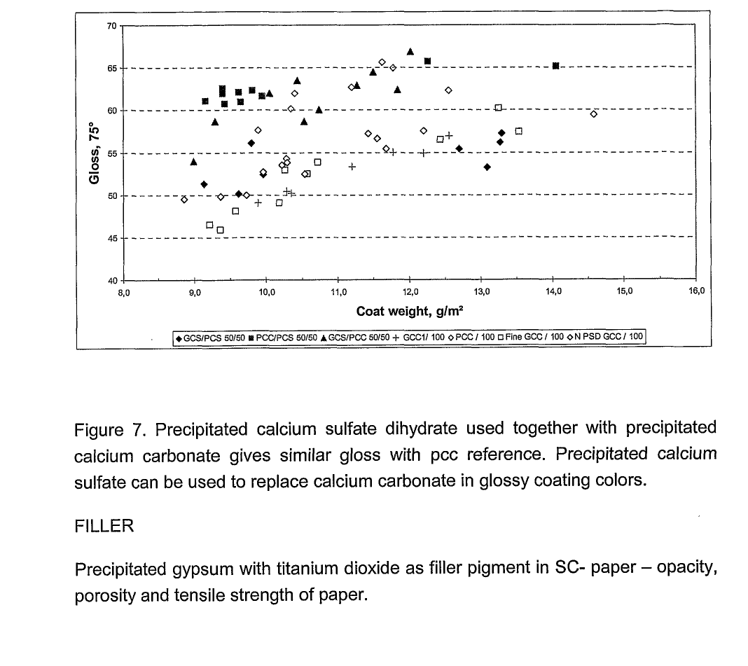

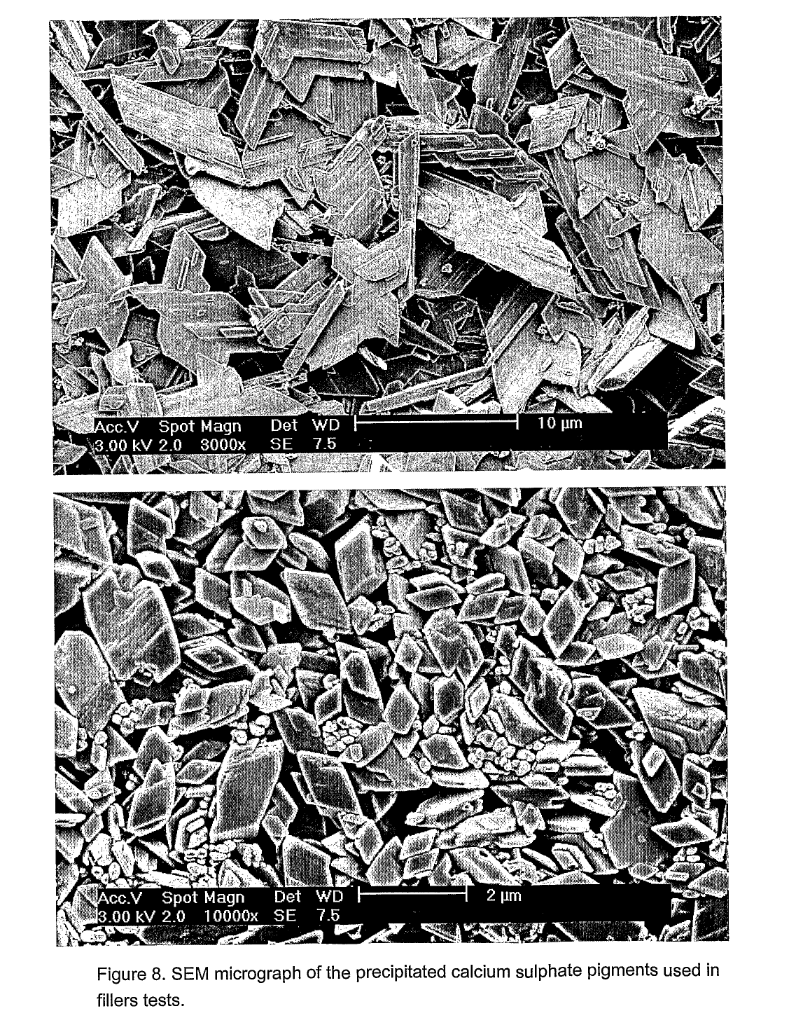

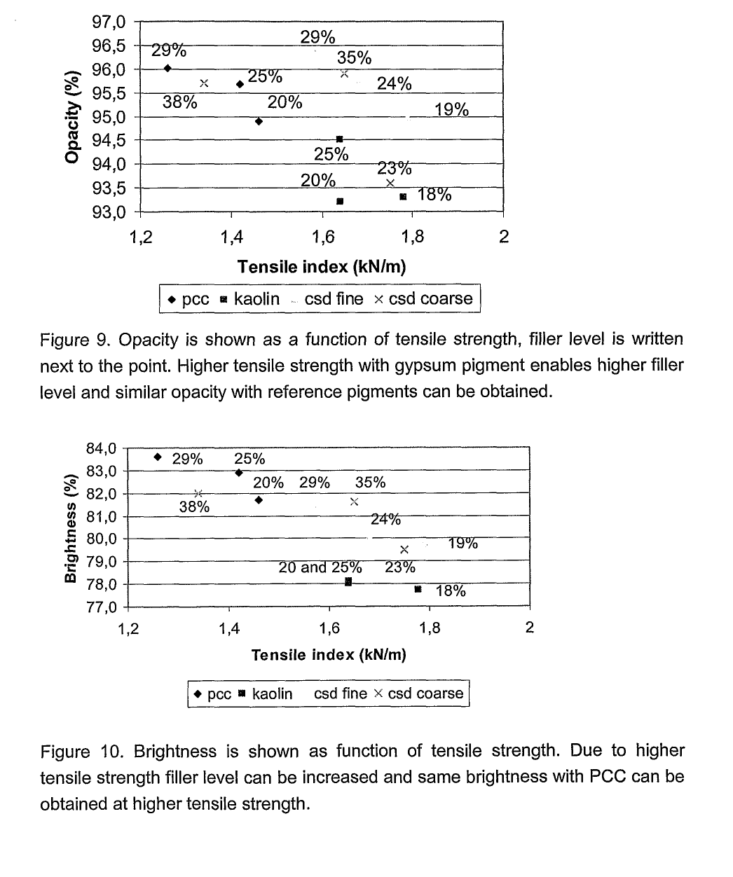

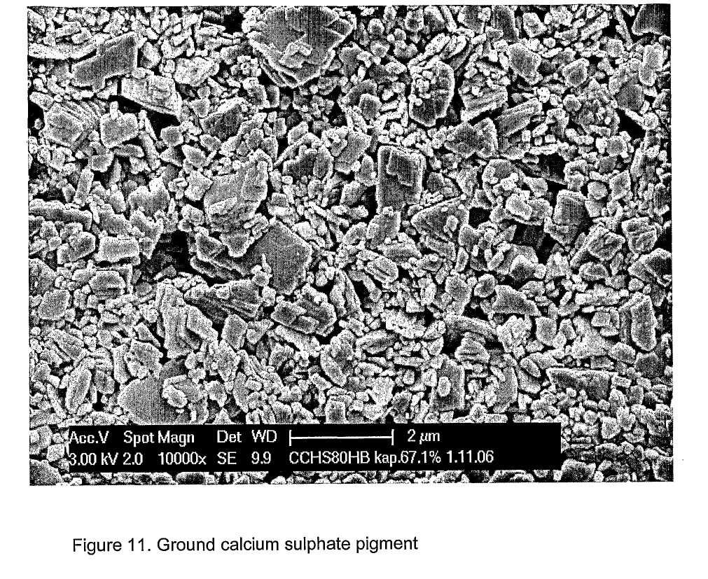

### EXAMPLES

### Example 1

1. 235.82 g of deionized water is placed into the cooled reactor, when the cooler bath temperature has reached 2° C.

2. Na-n-alkyl(C10-13)benzene sulfonate (NABS) habit modifier chemical 0.6761 g (55% purity gives 0.3719 g, 0.12% of HH weight) is added to the reactor.

3. When the cooler bath has reached a temperature of 2° C., the addition of fluidized bed calcined β-hemihydrate is started. The rotation speed of the stirrer is occasionally increased during the addition. The total amount of hemihydrate (HH) added is 313.5 g (total 549.9 g, giving 57% by weight of HH). The operation speed of the stirrer is set to 400 rpm.

4. pH of the hemihydrate slurry is adjusted to 7-7.3 using 10% NaOH-solution.

5. Wait for the formation of calcium sulfate dihydrate

6. The precipitated product is dispersed using a Diaf dissolver and Fennodispo A41 polyacrylate dispersant.

7. Other chemicals like biocide (Fennosan IT 21) are added.

8. Possible whitening treatment and screening

The obtained dihydrate gypsum is shown in FIG. 1.

Average particle size is 0.57 μm

The shape ratio is ca. 27.8

The aspect ratio is ca 3.46

Width of the particle size distribution is 0.775

### Example 2

1. 208.02 g of deionized water is placed into the cooled reactor, when the cooler bath temperature has reached 2° C.

2. 1.0599 g of EDDS (Ethylene diamine disuccinate) and 0.9591 g of Na₂-EDTA (Na-Ethylene diamine tetra acetic acid), together 2.019 g of habit modifier chemical as active substance is added to the reactor.

3. When the cooler bath has reached 2° C. temperature, the addition of fluidized bed calcined β-hemihydrate is started. Rotation speed of the stirrer is occasionally increased during the addition. Total amount of hemihydrate added is 313.5 g (a total weight of 523.54 g gives 59.9% by weight of HH). Operation speed of the stirrer is set to 250 rpm.

4. pH of the hemihydrate slurry is adjusted to 7-7.3 using 10% NaOH-solution.

5. Wait for the formation of calcium sulfate dihydrate

6. The precipitated product is dispersed using Diaf dissolver and Fennodispo A41 polyacrylate dispersant.

7. Other chemicals like biocide (Fennosan IT 21) are added.

8. Possible whitening treatment and screening

The obtained dihydrate gypsum is shown in FIG. 2

Average particle size is 0.838 μm

Shape ratio is ca. 6.2

Aspect ratio is ca. 1.73

Width of the particle size distribution 0.838

### Example 3

1. 208.02 g of deionized water is placed into the reactor, when the cooler bath temperature has reached 2° C.

2. 1.0599 g of EDDS (Ethylene Diamine Di Succinate) and 0.9591 g of Na₂-EDTA (Na-Ethylene Diamine Tetra Acetic acid), together 2.019 g habit modifier chemicals as active substance is added to the reactor.

3. When the cooler bath has reached a temperature of 2° C., the addition of fluidized bed calcined β-hemihydrate is started. The rotation speed of the stirrer is occasionally increased during the addition. The total amount of hemihydrate added is 313.5 g (the total weight is 523.54 g, giving 59.9% HH). The operation speed of the stirrer is set to 500 rpm.

4. pH of the hemihydrate slurry is adjusted to 7-7.3 using 10% NaOH-solution.

5. Wait for the formation of calcium sulfate dihydrate

6. The precipitated product is dispersed using Diaf dissolver and Fennodispo A41 polyacrylate dispersant.

7. Other chemicals like biocide (Fennosan IT 21) are added.

8. Possible whitening treatment and screening

Obtained dihydrate gypsum is shown in FIG. 3

Average particle size 0.78 μm

Shape ratio is ca. 6.3

Aspect ratio is ca. 1.73

Width of the particle size distribution is 0.658

### Example 4

1. 5625 g of fluidized bed calcined β-calcium sulfate hemihydrate is placed in MLH12 MAP laboratory mixer.

2. 12.4 g of habit modifier Na-n-alkyl(C10-13)benzene sulfonate (Paste A55 purity-% :55, which gives 6.82 g of active modifier) is mixed with 1875 g tap water (a total of 7512.4 g, giving 74.8% by weight of HH).

3. Water—habit modifier mixture is added to hemihydrate and mixing is started and speed is gradually increased to 225 rpm. Reaction is run at system pH.

4. Wait for the formation of calcium sulfate dihydrate

5. The precipitated product is dispersed using MLH12 MAP laboratory mixer and Fennodispo A41 polyacrylate dispersant.

6. Other chemical like biocide (Fennosan IT 21) are added.

7. Possible whitening treatment and screening

The obtained dihydrate gypsum is shown in FIG. 4

Average particle size is 0.88 μm

Shape ratio is ca. 6.19

Aspect ratio is ca. 2.90

The width of the particle size distribution is 1.06

### Example 5

1. 720 g of rotary kiln calcined β-calcium sulfate hemihydrate is placed in a Hobart N50 CE laboratory mixer

2. 1.57 g Na-n-alkyl (C10-13) benzene sulfonate (purity-% :55 which gives 0.8635 g active modifier) is added to 387.69 g of tap water (a total of 1109.26 g gives 64.9% by weight of HH)

3. Mixing is started at mixing level of 1 and Water—habit modifier mixture is added to the hemihydrate. Reaction is run at system pH.

4. Wait for the formation of calcium sulfate dihydrate.

5. The precipitated product is dispersed using Diaf dissolver and Fennodispo A41 polyacrylate dispersant.

6. Other chemicals like biocide (Fennosan IT 21) are added.

7. Possible whitening treatment and screening

Obtained dihydrate gypsum is shown in FIG. 5

Average particle size 1.06 μm

Shape ratio is ca. 11.4

Aspect ratio is ca. 2.43

Width of the particle size distribution is 1.07

The following table shows the reagents, their amounts, the reaction conditions and the results. The raw material in all examples was β-hemihydrate obtained by fluidized bed flash heating. The dispersing agent in all examples was Fennodispo A41.

TABLE

| | | CHM**, | | | | | | |
|---|---|---|---|---|---|---|---|---|
| | DMC*, | % of | | | | | | |
| | % by | HH^{a} | Tj, | | D₅₀***, | | | |
| Ex. | weight | weight | ° C. | pH | μm | SR**** | AR***** | WPSD****** |
| 1 | 57 | 0.12 | 2 | 7.0-7.3 | 0.57 | 27.8 | 3.46 | 0.775 |
| | | NABS^{b} | | | | | | |
| 2 | 59.9 | 0.64 | 2 | 7.0-7.3 | 0.838 | 6.2 | 1.73 | 0.838 |
| | | EDDS^{c} + | | | | | | |
| | | Na₂- | | | | | | |
| | | EDTA^{d} | | | | | | |
| 3 | 59.9 | 0.64 | 2 | 7.0-7.3 | 0.78 | 6.3 | 1.73 | 0.658 |
| | | EDDS^{c} + | | | | | | |
| | | Na₂- | | | | | | |
| | | EDTA^{d} | | | | | | |
| 4 | 74.9 | 0.12 | 20 | 7 | 0.88 | 6.19 | 2.90 | 1.06 |
| | | NABS^{b} | | | | | | |
| 5 | 64.9 | 0.12 | 20 | 7 | 1.06 | 11.4 | 2.43 | 1.07 |
| | | NABS^{b} | | | | | | |

*DMC = dry matter content
**CHM = crystallization habit modifier
**D₅₀ = weight average particle size
***SR = shape ratio (length per thickness)
****AR = aspect ratio (length per broadness)
*****WPSD = width of particle size distribution
^{a}HH = β-calcium sulfate hemihydrate
^{b}NABS = Na-n-alkyl(C10-13)benzene sulfonate
^{c}EDDS = Ethylene Diamine Di Succinate
^{d}Na₂-EDTA = Na-Ethylene Diamine Tetra-Acetic acid

1-19. (canceled)

20. A gypsum product consisting essentially of intact gypsum crystals obtained by crystallization and having a size from 0.1 to less than 2.0 μm.

21. The gypsum product according to claim 20, wherein the shape ratio of the crystals is at least 2.0:1.

22. The gypsum product according to claim 20, wherein the aspect ratio of the crystals is between 1.0 and 10.

23. The gypsum product according to claim 20, wherein the width of the particle size distribution is below 2.0.

24. The gypsum product according to claim 20, wherein the gypsum product is a coating pigment and consists of crystals having a size of between 0.1 and 1.0 μm.

25. The gypsum product according to claim 20, wherein the gypsum product is a filler pigment and consists of crystals having a size of between 1.0 and below 2.0 μm.

26. A process for the preparation of a gypsum product wherein calcium sulfate hemihydrate and/or calcium sulfate anhydrite, water, and a crystallization habit modifier are contacted so that the calcium sulfate hemihydrate and/or calcium sulfate anhydrite and the water react with each other and form a crystalline gypsum product, wherein the calcium sulfate hemihydrate and/or calcium sulfate anhydrite is/are used in such an amount that the reaction mixture formed from the calcium sulfate hemihydrate and/or calcium sulfate anhydrite, the water, and the crystallization habit modifier has a dry matter content of between 50 and 84% by weight, and that the mixing is carried on until the gypsum product is formed which consists essentially of intact crystals having a size between 0.1 and 2.0 μm.

27. The process according to claim 26, wherein the calcium sulfate hemihydrate and/or calcium sulfate anhydrite are used in such an amount that the reaction mixture formed from it/them, the water, and the crystallization habit modifier has a dry matter content of between 57 and 84% by weight.

28. The process according to claim 26, wherein the crystallization habit modifier is added to the water before the calcium sulfate hemihydrate and/or calcium sulfate anhydrite.

29. The process according to claim 26, wherein the crystallization habit modifier is a compound the molecule of which has one or several carboxylic or sulfonic groups, or a salt thereof.

30. A process according to claim 29, wherein the crystallization habit modifier is selected from the group consisting of ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), the di- tetra- and hexa-aminostilbenesulfonic acids and their salts, sodium aminotriethoxy succinate (Na₆-TCA), and the alkylbenzenesulfonates.

31. The process according to claim 26, wherein the crystallization habit modifier is used in an amount of 0.01 to 5.0%, based on the weight of the calcium sulfate hemihydrate and/or calcium sulfate anhydrite.

32. The process according claim 26, wherein the calcium sulfate hemihydrate and/or calcium sulfate anhydrite, the water, and the crystallization habit modifier are intermixed until the calcium sulfate hemihydrate and/or calcium sulfate anhydrite and the water have reacted into gypsum.

33. The process according to claim 26, wherein the crystallized or recovered gypsum is dispersed with a dispersing agent.

34. The process according to claim 33, wherein the dispersing agent is used in an amount of from 0.01 to 5.0%, based on the weight of the gypsum.

35. The process according to claim 26, wherein the formed, recovered, or dispersed gypsum is treated with additives such as biocides.

36. The process according to claim 26, wherein the formed, recovered, dispersed and with additives optionally treated gypsum is sieved to obtain gypsum particles having the desired size.

37. The process according to claim 26, wherein the formed, recovered, dispersed and with additives optionally treated or sieved gypsum is bleached.
